(19) United States
(12) Patent Application Publication
(10) Pub. No.: US 2026/0332189 A1
(43) Pub. Date: Oct. 22, 2026

(54) METHODS AND SYSTEMS FOR WTRU-CONTROLLED RECONFIGURABLE INTELLIGENT SURFACES

(71) Applicant: InterDigital Patent Holdings, Inc., Wilmington, DE (US)

(72) Inventors: Tezcan Cogalan, London (GB); Arman Shojaeifard, London (GB); Kyle Jung-Lin Pan, Saint James, NY (US); Deepa Gurmukhdas Jagyasi, London (GB); Guodong Zhang, Woodbury, NY (US)

(73) Assignee: InterDigital Patent Holdings, Inc., Wilmington, DE (US)

(21) Appl. No.: 19/100,496

(22) PCT Filed: Aug. 18, 2023
(86) PCT No.: PCT/US2023/072435

§ 371 Date: Jan. 31, 2025

Related U.S. Application Data
(60) Provisional application No. 63/399,350, filed on Aug. 19, 2022.

(51) Int. Cl. H04B 7/04

(52) U.S. Cl. CPC H04B 7/04013

(57) ABSTRACT

A first wireless transmit/receive unit (WTRU) may receive a first discovery message associated with a reconfigurable intelligent surface (RIS). The first WTRU may send a solicitation message to a RIS controller in response to receipt of the first discovery message, the solicitation message comprising one or more of capability information associated with the first WTRU, one or more RIS capabilities, one or more RIS modes, or an indication of a second WTRU. The first WTRU may receive a solicitation response message from the RIS controller in response to the solicitation message, the solicitation response message comprising RIS control information associated with the RIS. The first WTRU may send a transmission to the second WTRU via the RIS based on the RIS control information.

### CROSS REFERENCE TO RELATED APPLICATIONS

This application claims the benefit of U.S. Provisional Application Patent Application No. 63/399,350, filed Aug. 19, 2022. U.S. Provisional Application No. 63/399,350 is incorporated herein by reference in its entirety.

### BACKGROUND

The techniques described herein relate to the field of computing and communications and, more particularly, to methods, apparatus, systems, architectures and interfaces for computing and communications in an advanced or next generation wireless communication system, including communications carried out using a new radio and/or new radio (NR) access technology and communication systems. Such NR access and technology, which may also be referred to as 5G and/or 6G, etc., and/or other similar wireless communication systems and technology may include features and/or technologies for a reconfigurable intelligent surface (RIS). As described herein, an RIS may be capable of adapting to radio environment conditions. For example, a RIS may be capable of electronically controlling the propagation of radio frequency (RF) signals impinging on a surface of the RIS.

### SUMMARY

A reconfigurable intelligent surface may be controlled by a wireless transmit receive unit (WTRU), for example, to communicate with another WTRU via the RIS. The WTRU may receive a discovery message associated with the RIS. For example, the discovery message may include one or more capabilities associated with the RIS (e.g., reflection, absorption, or refraction). The WTRU may transmit a solicitation message in response to receiving the discovery message. For example, the solicitation message may include an indication of a source WTRU, an indication of a target WTRU, and a requested capability (e.g., of the one or more capabilities associated with the RIS included in the discovery message). The WTRU may receive a response to the solicitation message, e.g., that includes an indication that the solicitation message is accepted by the RIS. The WTRU may establish a link between the source WTRU and the target WTRU via the RIS. For example, the source WTRU, the target WTRU, and the RIS may be associated with a personal IoT network (PIN). For example, the source WTRU, the target WTRU, and the RIS may associated with a customer premises network (CPN).

A first wireless transmit/receive unit (WTRU) may receive a first discovery message associated with a reconfigurable intelligent surface (RIS). The first discovery message comprises one or more capability parameters associated with the RIS. The first WTRU may send a solicitation message to a RIS controller in response to receipt of the first discovery message, the solicitation message comprising one or more of capability information associated with the first WTRU, one or more RIS capabilities, one or more RIS modes, or an indication of a second WTRU. The one or more RIS capabilities may include reflection, refraction, and/or absorption. The one or more RIS modes may include a passive mode, an active mode, and/or a semi-active mode. The first WTRU may receive a solicitation response message from the RIS controller in response to the solicitation message, the solicitation response message comprising RIS control information associated with the RIS. The solicitation response message indicates that the second WTRU has been discovered.

The first WTRU may send a transmission to the second WTRU via the RIS based on the RIS control information. The transmission may be sent to the second WTRU using an RIS adaptation layer that is controlled by the first WTRU. The first WTRU may determine that the second WTRU has been discovered. The first WTRU may send a second discovery message to the second WTRU via the RIS. The first WTRU may receive a second discovery message response from the second WTRU via the RIS. The first WTRU may establish a unicast link with the second WTRU via the RIS. The RIS may be a PIN element with RIS capability (PERC).

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment.

FIG. 2 illustrates an example wireless communication system that includes a reconfigurable intelligent surface (RIS);

FIG. 3 illustrates an example home automation personal internet of things (IoT) network (PIN);

FIG. 4 illustrates an example customer premises networks (CPNs);

FIGS. 5 and 6 illustrate examples associated with ProSe direct discovery;

FIG. 7 illustrates an example topology of a RIS-integrated CPN;

FIG. 8 illustrates an example topology of a RIS-integrated PIN;

FIG. 9 illustrates an example protocol stack;

FIG. 10 illustrates an example call flow for RIS discovery and/or using a RIS for WTRU-to-WTRU communications; and

FIG. 11 illustrates an example call flow for PIN Element with RIS Capability (PERC) discovery and controlling of a RIS using a PIN Element with Management Capability PEMC or a PIN Element with Gateway Capability (PEGC).

FIG. 12 illustrates an example control plane protocol stack for WTRU-to-WTRU communication via RIS.

### DETAILED DESCRIPTION

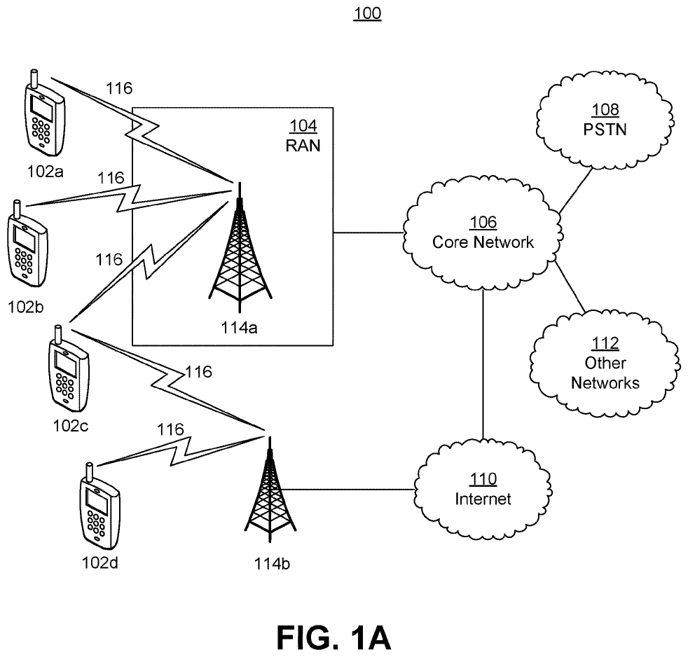

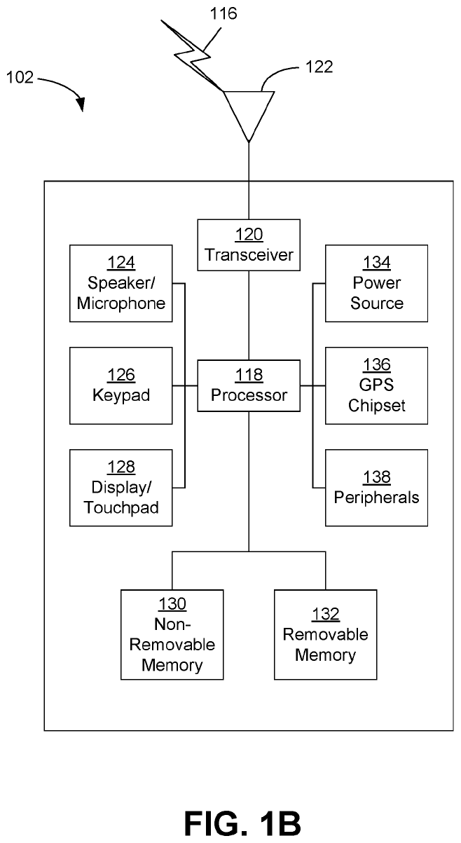

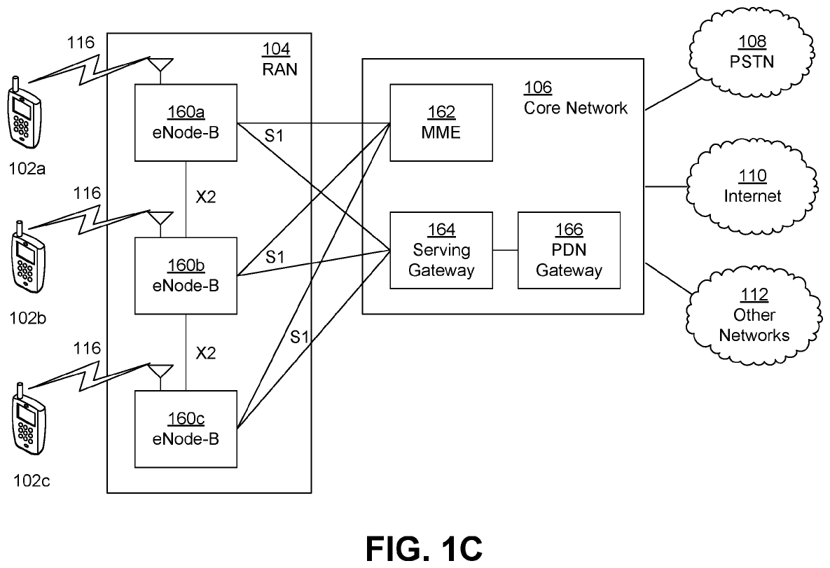

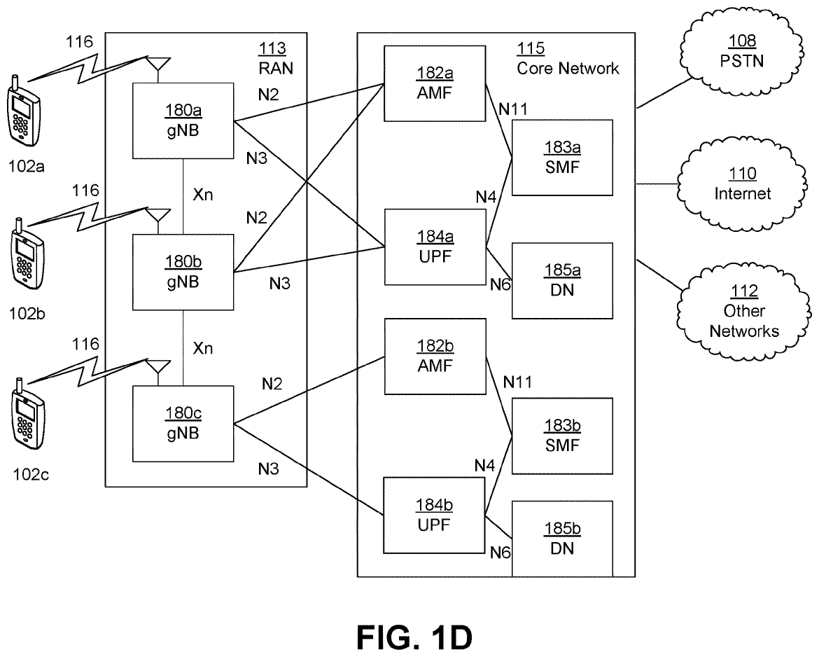

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions. The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80×80 configuration. For the 80×80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80×80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUS 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As described herein, a reconfigurable intelligent surface (RIS) may refer to a type of network node that uses smart radio surfaces of one or more (e.g., small) antennas or metamaterial elements. For example, the smart radio surfaces of the one or more antennas may be used to control the propagation environment, e.g., through tunable scattering of electromagnetic (EM) waves. The surfaces may have reflection, refraction, and absorption properties, which may be configured, reconfigured, and/or adapted to specific radio channel environment, for example, using a microcontroller (e.g., field-programmable gate array or FPGA). The configuration of the RIS may be performed or assisted by the network, e.g., through a separate control signaling link for exchanging relevant side control information.

A RIS may be used to provide smart and reconfigurable wireless environment (e.g., for future wireless communication systems such as beyond 5G and 6G). For example, an RIS may include a planar surface with a number (e.g., a large number) of elements, each of which may be able to independently induce/cause a controllable amplitude and/or phase change to incident signals. For example, by densely deploying RISs in a wireless network, the wireless channels between transmitters and receivers may be (e.g., flexibly) reconfigured, for example, to achieve desired realizations and distributions, address wireless channel fading and interference, and/or improve wireless communication capacity and reliability. A RIS may be used to create a virtual line-of-sight (LOS) link to bypass obstacles, for example, via smart reflection, which may add signal paths toward a desired direction. For example, a RIS may be used to improve a channel rank, refine channel statistics or distribution, and/or suppress or nullify interference and/or noise.

A RIS may be integrated into existing wireless systems, e.g., cellular system. For example, a RIS may be deployed (e.g., massively deployed) in wireless networks to enhance spectral and energy efficiency, for example, in a cost-effective manner. RIS may lead to fundamental paradigm shifts of wireless system and/or network designs from the existing MIMO system without RIS to a RIS-aided MIMO system. Since RISs are associated with lower cost (e.g., than other network nodes), RISs may be more densely deployed in wireless network in a cost-effective manner.

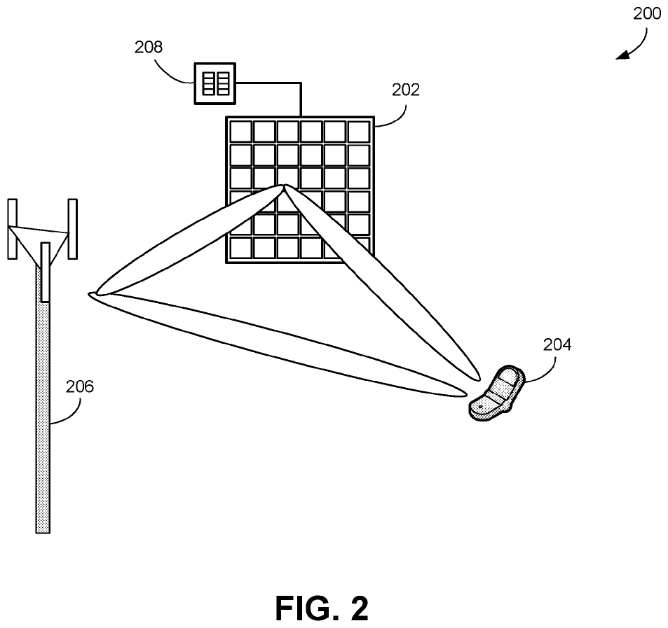

FIG. 2 illustrates an example wireless communication system 200 that includes a RIS 202, a WTRU 204, a RIS controller 208, and a network node (e.g., such as a gNB or TRP) 206. A RIS 202 may be deployed in several scenarios, including, for example, RIS-based massive MIMO systems and/or RIS-based coverage enhancement. For example, in a RIS-based massive MIMO scenario, an RIS 202 may be deployed near (e.g., alongside) a gNB/TRP 206, e.g., to improve spectral efficiency. For example, in a RIS-based coverage enhancement scenario, a RIS 202 may be deployed away from a gNB/TRP 206, e.g., to enhance network coverage (e.g., for both weak coverage areas or coverage holes due to obstructions for line-of-sight link from gNB/TRP 206 to WTRU 202) and/or to extend the coverage area of a gNB/TRP 206.

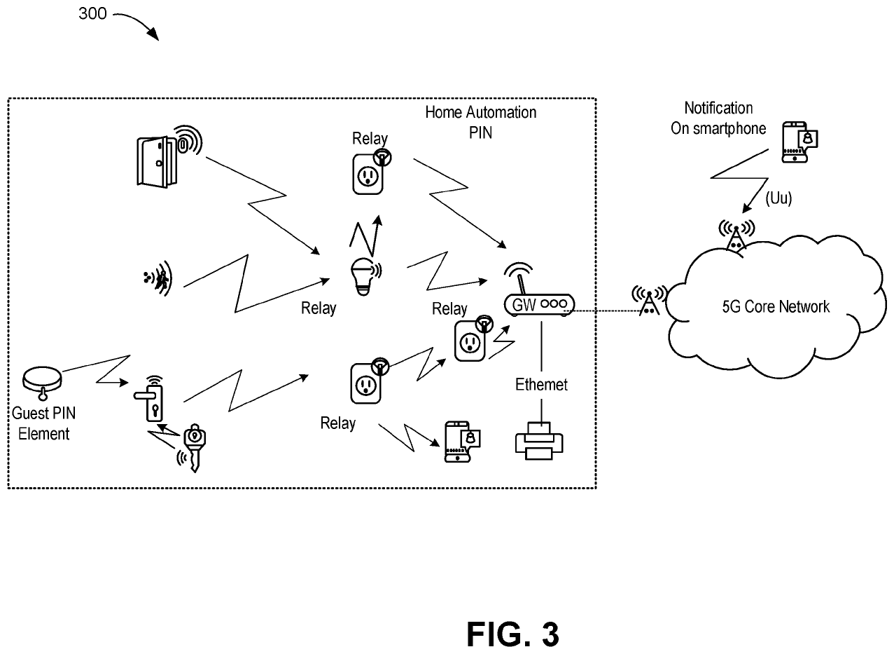

In certain scenarios, personal internet of things (IoT) networks (PIN) may be implemented. One or more of the following may apply. FIG. 3 illustrates an example home automation PIN 300. Certain IoT feature may be designed for devices that communicate using traditional cellular networks. Devices with IoT capabilities may exhibit improved power consumption performance, which may enable efficient deployment (e.g., efficient massive deployment).

When multiple IoT devices are deployed in a private environment, the WTRUs with IoT capabilities may be organized under a PIN. For example, in home environment, security sensors, smart lights, smart plugs, printers, cell phones, etc. may be managed by a residential gateway and communicate with each other. In this case, the devices in the home may constitute a PIN. Each of the devices (e.g., security sensors, smart lights, smart plugs, printers, cell phones, etc.) may be referred to as a PIN element, and different PIN elements may be associated with different capabilities. For example, a residential gateway may be a PIN element that is associated with a gateway capability (e.g., PIN GW) and/or may be used to provide connections between PIN elements and connections between 5G network and PIN elements. Also, or alternatively, a residential gateway may support PIN management function. Certain PINs may include wearable devices (e.g., smart watch, VR/AR glasses, airpods, and/or the like). For example, in such a PIN, a WTRU (e.g., a cell phone) may be configured as a PIN element that is associated with a gateway capability and a PIN element that is associated with a management capability. The wearable devices (e.g., smart watch, VR/AR glasses, airpods, etc.) may communicate with other devices in the PIN via the WTRU (e.g., a WTRU this is associated with a gateway capability). Also, or alternative, the wearable devices may communicate with other WTRUs (e.g., WTRUs that are not in the PIN) via an external network (e.g., a 5G network).

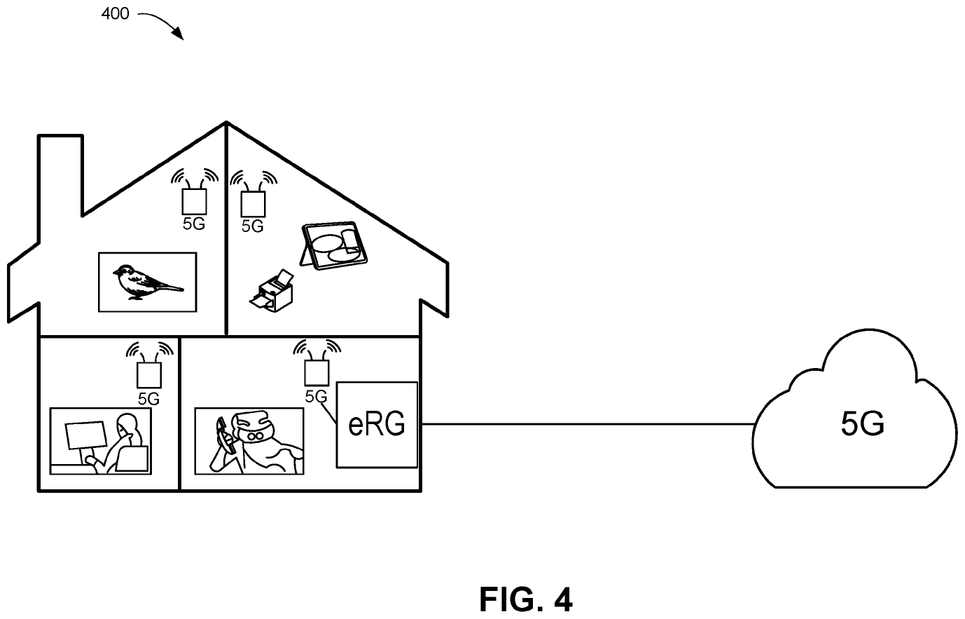

In certain scenarios, residential/customer premises networks (CPNs) may be implemented. FIG. 4 illustrates an example associated with CPNs 400 in an in-home scenario. One or more of the following may apply. In certain scenarios, houses may suffer from coverage problems, e.g., due to the number of floors and other obstacles (e.g., walls, doors, columns, furniture). Outdoor-to-indoor coverage may be an issue at 3.5 GHz, mmWave, and/or higher frequencies. Coverage may be provided using indoor solutions may be the answer; for example, premises radio access stations (PRASs) may be connected via fixed access. Certain organizations (e.g., 3GPP, Broadband Forum) may provide/consider implementations that include fixed access, e.g., as part of a 5G system (e.g., wireline wireless convergence architecture implementations).

In certain scenarios (e.g., most scenarios), houses may include a single entry network point, e.g., where an evolved residential gateway (eRG) may be installed. Connectivity to the eRG may be implemented via fixed access, 5G fixed wireless access, and/or a hybrid fixed access/5G fixed wireless access.

In certain scenarios, connectivity may not be provided throughout a house from a single PRAS. For example, if concrete floors and/or walls are present, one or more PRASs may be deployed in a house, which may provide sufficient coverage (e.g., even in the attic, cellular, and garage). At mmWave frequencies, a PRAS may be implemented in each room (e.g., living room, kitchen, bedrooms, attic, etc.), for example, as signal and channel of higher frequencies may be blocked (e.g., significantly blocked) by walls.

Proximity-based services (ProSe) may include services that are provided (e.g., by the 3GPP system) based on WTRUs being in proximity to each other. To provide proximity services, WTRUs may perform a ProSe discovery procedure, e.g., to discover other WTRUs in proximity. There are two ProSe discovery modes: Model A and model B.

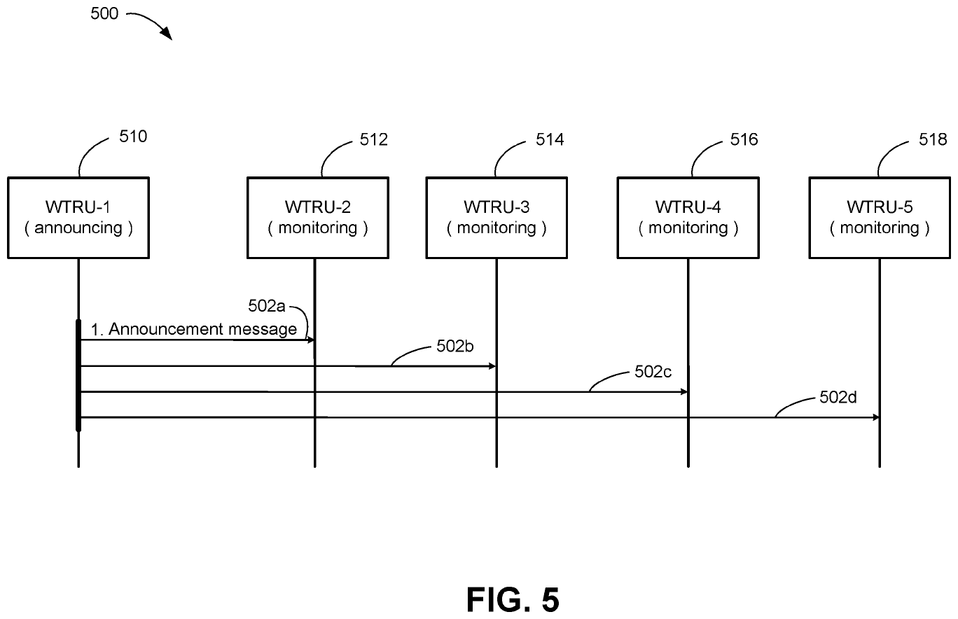

FIG. 5 illustrates an example ProSe direct discovery 500 using model A. In model A, a WTRU (e.g., an announcing WTRU 510) may broadcast one or more announcement messages 502a, 502b, 502c, 502d that include a ProSe code (e.g., which may be associated with the announcing WTRU's ID and/or associated to a service provided by the announcing WTRU 510). Other WTRUs 512, 514, 516, 518 (e.g., monitoring WTRUs) that receive the respective announcement messages 502a, 502b, 502c, 502d may determine that the announcing WTRU 510 is in proximity.

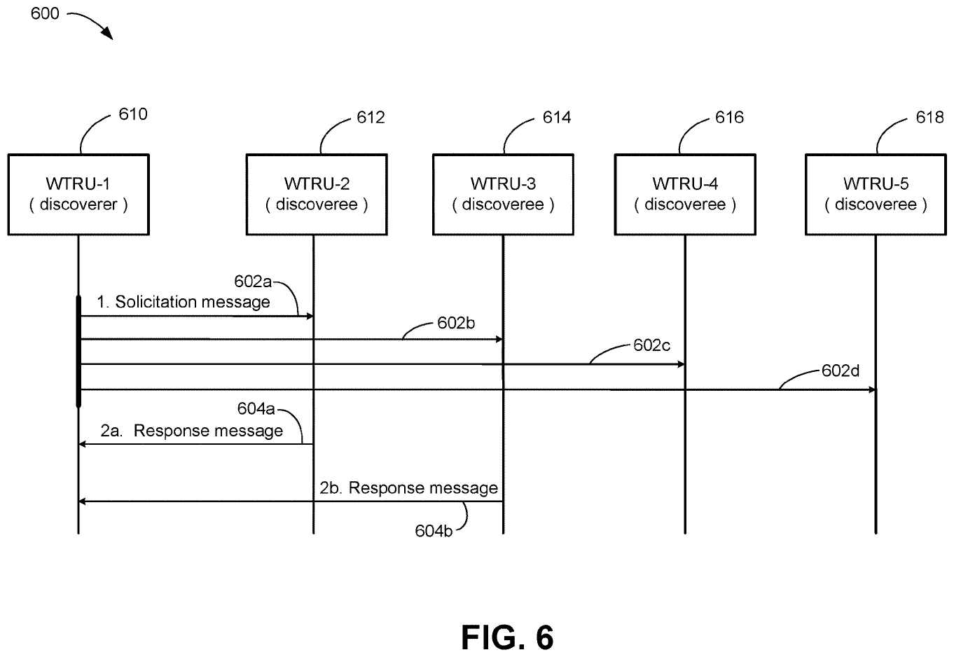

FIG. 6 illustrates an example ProSe direct discovery 600 using model B. In model B, a WTRU (e.g., a discoverer WTRU 610) may broadcast one or more solicitation request messages 602a, 602b, 602c, 602d that includes a ProSe query code (e.g., which may be associated with the WTRU's ID to be discovered and/or associated to a service to be discovered). One or more of the other WTRUs 612, 614, 616, 618 (e.g., discoveree WTRUs) that receive the solicitation request message may respond to the request (e.g., by sending a response message 604a, 604b), for example, that includes a ProSe response code (e.g., which may be associated with the discoveree WTRU's ID and/or associated with a ProSe service provided by the discoveree WTRU). The discoverer WTRU 610 may determine that the discoveree WTRU (e.g., such as WTRU 612 and WTRU 614) is in proximity.

A RIS may be used to achieve smart and reconfigurable wireless environment for future wireless communication systems, e.g., such as beyond 5G and 6G. For example, an RIS may reflect, refract, and/or absorb incident beams to a desired direction (e.g., or undesired direction, in case of absorption). In certain scenarios, a RIS deployment may include a RIS-integrated network, which may be used to improve cellular network spectral efficiency, network coverage, etc. In such deployments, the control of radio surfaces of one or more antennas (e.g., many small antennas) or metamaterial elements of RIS may be performed by a base station. A RIS may also, or alternatively, be part of a smaller scale, personal indoor network, for example, such as a residential network or PIN (e.g., where direct WTRU-to-WTRU communication without involvement of network/base station may occur). Control of the RIS (e.g., for reflection, refraction, and/or absorption of the incident beams) may be assigned to one or more WTRUs (e.g., sets of WTRUs), for example, for WTRU-to-WTRU(s) unicast (or multicast) communications.

Described herein are techniques that may be used to enable the discovery of a RIS for WTRU-to-WTRU communications. Described herein are techniques that may be used to enable a WTRU to control a RIS, e.g., in personal/customer premises networks (e.g., that operate in licensed and/or unlicensed spectrum).

As described herein, the term control signaling may include any control signaling and/or side control information that is used to operate and/or optimize the operation of RIS-integrated networks. As described herein, the terms “RIS” and “RIS controller” may be used interchangeably. As described herein, the term “public network operator” may be used to represent the operator that provides outdoor coverage and/or has authorization to operate in the licensed spectrum that a given personal/indoor network operates in. As described herein, WTRU(s) may have already successfully performed initial access and/or have already established a communication link to an access node via a RIS.

RIS-integrated personal networks may be associated with a topology and/or configuration. One or more of the following may apply. An eRG/PRAS may be used to configure a RIS for RIS-integrated CPN. A PEGC/PEMC may be used to configure the RIS for RIS-integrated PIN.

RIS discovery for WTRU-to-WTRU communications may be performed via a RIS. One or more of the following may apply. A certain protocol stack may be used for RIS discovery messages. Model A and/or model B discovery models may be used for RIS discovery. A RIS controller may send/receive solicitation messages/requests, e.g., that indicate the RIS's capabilities, to eRG/PRAS/PEGC/PEMC. The RIS controller may send/receive discovery/announcement messages/requests (e.g., based on RIS' capabilities) to eRG/PRAS/PEGC/PEMC. The eRG/PRAS may configure the RIS to reflect impinging signals back to its source, and/or may transition CPN WTRU(s) to a scanning mode (e.g., where the CPN WTRU(s) transmit signals and measure the bounced back signal power to discover a RIS).

A RIS may be controlled by a WTRU. One or more of the following may apply. A control plane protocol stack at the RIS controller may be used for WTRU-to-WTRU communications. For example, the control plane protocol stack may include RLC, MAC, PHY, and/or RIS adaptation layers, which may be placed over the RLC layer and/or may be used to tune/configure properties of RIS and/or RIS elements. The RIS adaptation layer, RLC, MAC and PHY may or may not be terminated at RIS controller. For example, the RIS adaptation layer may be terminated at RIS controller, and may be used (e.g., only used) to adapt the RIS elements to reflect the signal from a source WTRU to a destination WTRU. The RIS adaptation layer may be controlled by the source/destination WTRU, e.g., based on the status of PC5-RLC, PC5-MAC and PC5-PHY layers between the source/destination WTRU and the RIS controller. The control plane protocol stack at the RIS controller for WTRU-to-WTRU communications may include (e.g., may only include) the PHY and RIS adaptation layer. The RIS adaptation layer may support multiple access (e.g., where a first set of RIS elements may be dedicated for the transmission from the source WTRU to the destination WTRU and a second set of RIS elements may be dedicated for the transmission from the destination WTRU to the source WTRU). The RIS adaptation layer may support multiple access where a set of RIS elements may be dedicated for WTRU-to-WTRU transmissions and another set of RIS elements may be dedicated for gNB/PRAS/PEMC/PEGC to WTRUs (e.g., including PIN elements, CPN WTRUs, WTRUs) transmission. The RIS adaptation layer may support multicast transmissions, unicast transmissions, and/or WTRU-to-WTRU transmissions.

A RIS may be integrated into personal networks (e.g., RIS-integrated personal networks). One or more of the following may apply. RIS-integrated personal networks may be considered as part of one or more different topologies, including, for example, RIS-integrated CPNs and/or RIS-integrated PINs.

In the case of RIS-integrated CPNs, the topology of RIS-integrated residential network may include one or more of the following: a base station; a RIS controller and RIS; an evolved residential gateway (eRG); and/or a premises radio access station (PRAS). For example, the RIS controller and RIS may include a micro-controller, which may be used to determine the response(s) of the RIS (e.g., in the electromagnetic domain) according to control information from RIS controller. For example, the eRG may be a gateway between the public network operator (e.g., fixed, mobile, and/or cable) and a CPN within a residence, office and/or shop. For example, the PRAS may include a base station installed at a CPN, for example, for use within a residence, office and/or shop.

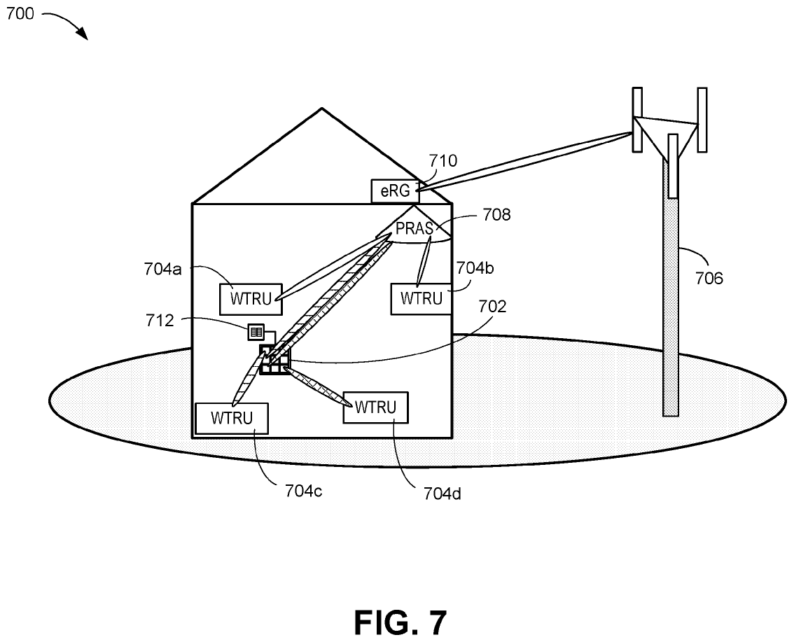

FIG. 7 illustrates an example topology of a RIS-integrated CPN 700. One or more of the following may apply. The CPN 700 may be a network located within premises (e.g., a residence, office or shop), which may be owned, installed and/or (e.g., at least partially) configured by a customer of a public network operator. The premises (e.g., residential area including residence, office or shop) may be within the network's coverage. The CPN 700 may comprise a RIS 702, a RIS controller 712, an eRG 710, a PRAS 708, and one or more WTRUs 704a, 704b, 704c, 704d. The eRG 710 and PRAS 708 may be within the premises. The PRAS 708 may provide access to a system (e.g., the 5G system) for WTRUs 704a, 704b, 704c, 704d within the premises, and/or may be connected (e.g., wired or wirelessly connected) to an eRG 710. The eRG 710 may be connected to the same system (e.g., the 5G system), for example, via wireless and/or wireline links. Depending on the relevant premises, one or more PRASs (e.g., such as the PRAS 708) may be installed in a single CPN.

A RIS 702 may be used in the CPN 700, for example, to extend the coverage within a residential area for a PRAS(s) 708 and/or for WTRUs 704a, 704b, 704c, 704d that are seeking WTRU-to-WTRU communication within the residential network.

In certain scenarios, the RIS 702 and RIS controller 712 may be managed by a public network operator, for example, via the eRG 710. The public network operator may enable the eRG 710 to control the RIS controller 712. The public network operator may configure (e.g., pre-configure and/or re-configure) the RIS controller 712, for example, to receive control signaling from the eRG 710.

In certain scenarios, the public network operator may enable the PRAS 708 to control the RIS controller 712. For example, the public network operator may configure (e.g., pre-configure and/or re-configure) the RIS controller 712 to receive control signaling from the PRAS 708.

In certain scenarios, the RIS 702 and RIS controller 712 may be managed by a customer of a public network operator and/or an owner of an eRG 710 (e.g., that may be different than the public network operator providing coverage to the relevant residential area). The RIS 702 and/or RIS controller 712 may be configured (e.g., pre-configured and/or re-configured), for example, by the customer and/or the owner of the eRG to receive control signaling from the eRG 710 and/or the PRAS 708.

In certain scenarios, the public network operator may activate/deactivate or turn ON/OFF a RIS 702. For example, the public network operator may activate and/or deactivate a RIS 702 based on the frequency band or bandwidth part (BWP) that a given CPN/PRAS operates. In a first CPN (e.g., such as the CPN 700), for example, the operating frequency/BWP may include a specific location/floor (e.g., for security or interference management concerns). If a RIS 702 is used to extend coverage in the first CPN 700, the performance/QoS/KPI of certain WTRU(s) (e.g., of the WTRU(s) connected to an outdoor or another close by indoor network that operates in the same frequency/BWP) may degrade. For example, the performance measurements may include measurements that implicitly and/or explicitly take into account interference (e.g., such as RSRQ, SINR and/or unwanted RIS re-radiation).

In certain scenarios, one or more (e.g., multiple) PRASs (e.g., such as the PRAS 708) may be implemented within a CPN. If, for example, multiple PRASs are implemented within a CPN, a public network operator and/or eRG 710 may be used to enable the control of RIS 702 via a PRAS (e.g., one of the multiple PRASs).

A RIS may be integrated into a PIN (e.g., RIS-integrated PINs). One or more of the following may apply. In the case of RIS-integrated PINs, the topology may include one or more of the following: a base station; a RIS controller and RIS; a PIN Element (PE); a PIN Element with Gateway (GW) Capability (PEGC); and/or a PIN element with Management (Mgmt) Capability (PEMC). For example, the RIS controller and RIS may include a micro-controller, which may be used to determine the response of RIS (e.g., in the electromagnetic domain), for example, according to control information from the RIS controller. The PE may include WTRUs and devices that are configured to communicate within the PIN. The PEGC may include WTRU PE(s) that are able to provide connectivity to and from other networks (e.g., a 5G network) and the PIN Elements that use PIN direct connections. The PEMC may include PE(s) that are associated with management capability (e.g., has the capability to manage the PIN).

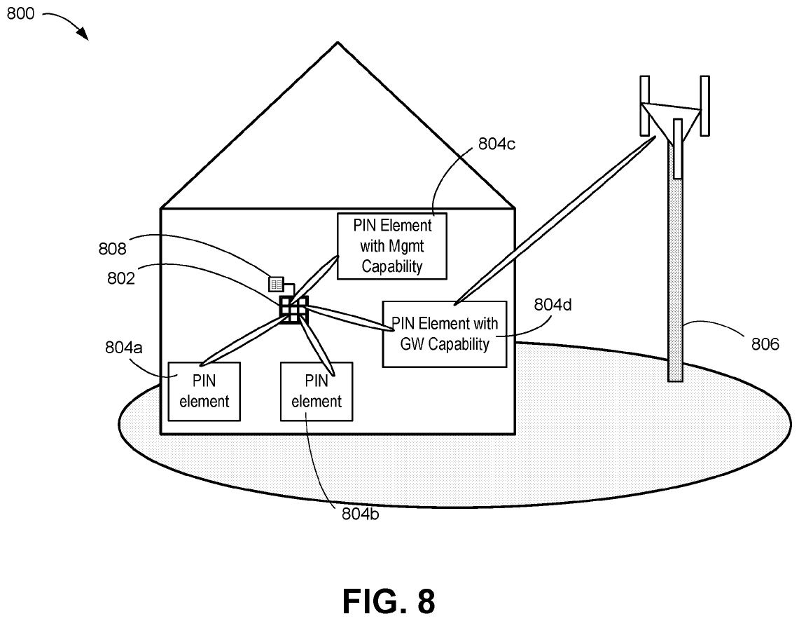

FIG. 8 illustrates an example topology of a RIS-integrated PIN 800. One or more of the following may apply. A PIN 800 may include a configured and managed group of devices, including, for example, a WTRU and/or one or more PEs 804a, 804b, 804c, 804d or WTRUs that are authorized (e.g., pre-authorized) to communicate with each other. A PIN may be implemented within an indoor or an outdoor environment. The PEs 804a, 804b, 804c, 804d may use PIN connections (e.g., direct connections) and/or a relay for end-to-end communication. Direct connections in the PIN 800 may, for example, be implemented via licensed spectrum (e.g., via 3GPP licensed spectrum and/or direct device connection). The PEMC 804c may receive information relating to PEs (e.g., such as their identity, capability), and may manage the PIN. The PEGC 804d may be connected to another network (e.g., a 5G system), for example, in order to provide direct or indirect connection between one or more of the PEs 804a, 804b, 804c, 804d and the other network. A single PIN element may be associated with both the Mgmt and GW capabilities. A PIN may include at least one PEGC (e.g., such as the PEGC 804d) and a PEMC (e.g., such as the PEMC 804c).

As shown in FIG. 8, an RIS 802 may be used to extend the coverage for the PIN 800 and/or the coverage for PEs 804a, 804b, 804c, 804d (e.g., PEs that are seeking PIN direct communication within the PIN network).

In certain scenarios, the RIS 802 and RIS controller 808 may be managed by a public network operator, e.g., via PEMC 804c. For example, the public network operator may enable the PEMC 804c to control the RIS controller 808. The public network operator may configure (e.g., pre-configure and/or re-configure) the RIS controller 808, for example, to receive control signaling from the PEMC 804c.

In certain scenarios, the public network operator may be used to enable the PEGC 804d to control the RIS controller 808. The public network operator may configure (e.g., pre-configure and/or re-configure) the RIS controller 808 to receive control signaling from the PEGC 804d.

In certain scenarios, the RIS 802 and RIS controller 808 may be managed by a PIN owner (e.g., a PIN owner that may be a public network operator). The RIS 802 and/or RIS controller 808 may be configured (e.g., pre-configured and/or re-configured) by the PIN owner, for example, to receive control signaling from the PEMC 804c and/or PEGC 804d.

In certain scenarios, a public network operator may activate/deactivate or turn ON/OFF a RIS 802. For example, a public network operator may activate/deactivate a RIS 802 based on the frequency band or bandwidth part (BWP) that the PIN direct communication operates on. For example, in a PIN direct connection, the operating frequency/BWP may include a specific location/floor (e.g., for security concerns and/or interference management). If a RIS 802 is implemented in the PIN 800 to extend the coverage for PIN direct communications, the performance/QoS/KPI of certain WTRU(s) may degrade (e.g., WTRU(s) that are connected to an outdoor or another close by indoor network that operates in the same frequency/BWP). For example, the performance measurements may include measurements that implicitly and/or explicitly take into account interference (e.g., such as RSRQ, SINR and/or unwanted RIS re-radiation).

In certain scenarios, one or more (e.g., multiple) PEMCs (e.g., such as the PEMC 804c) and/or PEGCs (e.g., such as the PEGC 804d) may be implemented within a single PIN. If, for example, multiple PEMCs and/or PEGCs are implemented within a single PIN, a public network operator and/or PIN owner may enable the control of a RIS (e.g., such as the RIS 802) to one or more of the PEMCs and/or the PEGCs.

In certain scenarios, one or more (e.g., multiple) PEMCs and/or PEGCs may be implemented within a single PIN. If, for example, multiple PEMCs and/or PEGCs are implemented within a single PIN, a public network operator and/or PIN owner may enable control of the RIS to the PEMCs and/or the PEGCs (e.g., in a manner similar to multiple access/resource allocation).

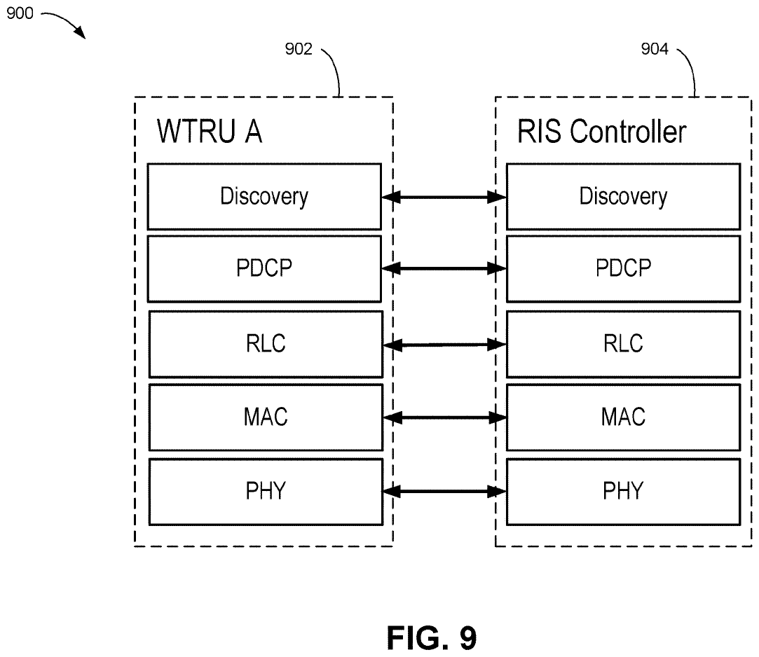

RIS discovery may be performed for WTRU-to-WTRU communications (e.g., via a RIS). One or more of the following may apply. FIG. 9 illustrates an example protocol stack 900 that may be used for RIS discovery messages. One or more of the following may apply. A RIS controller 904 may use a protocol stack of discovery message, e.g., as shown in FIG. 9. For example, the RIS controller 904 may use model A and/or model B discovery models.

In model A, for example, the RIS controller 904 may announce its presence to other WTRUS. When the RIS controller broadcasts its announcement message, the WTRU(s) 902 may receive direct discovery related parameters including, for example, discovery code, filter, etc. The WTRU 902 may also, or alternatively, receive capability parameters that indicate the RIS capability (e.g., such as reflection, refraction and/or absorption). In case the RIS can support more than one of the capabilities noted, the capability parameter may include the list of capabilities. In certain scenarios, the capability of the RIS may be considered as the RIS mode (e.g., passive, semi-active, or active RIS).

In model B, the RIS controller 904 may attempt to discover which WTRU(s) are proximate to the RIS. When the RIS controller 904 broadcasts its discovery message, the RIS controller 904 may attempt to discover and/or identify the WTRUs 902 around the RIS that may request (e.g., need) signal reflection, refraction, and/or absorption. When the WTRU(s) 902 around the RIS receive the RIS controller's discovery message, the WTRU(s) 902 may send a solicitation message to the RIS controller 904. For example, the solicitation message may include the relevant RIS capability(ies) (e.g., reflection, refraction, and/or absorption), RIS mode (e.g., passive, semi-active, or active), the WTRU's capability information, and/or destination WTRU information. In certain scenarios, a RIS controller 904 may receive a solicitation message, and may send a discovery message to the destination WTRU 902. In certain scenarios, the RIS controller 904 may respond to the solicitation message sent by the WTRU 902. For example, the RIS controller's response may include information relating to control of the RIS (e.g., how to and what to control on the RIS). In response to receiving a solicitation message response, the WTRU 902 may control the RIS to send discovery message to the destination WTRU 902.

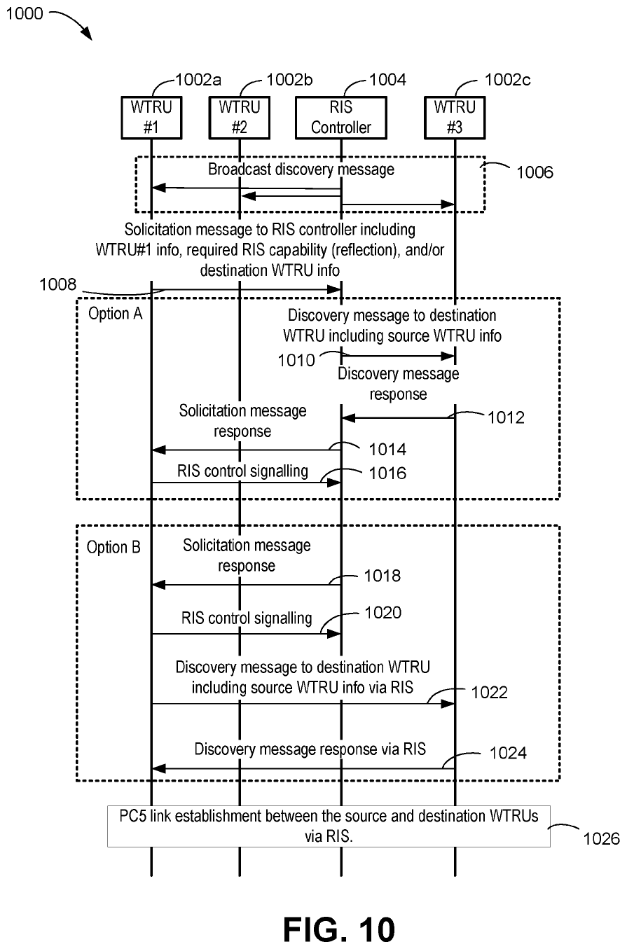

FIG. 10 illustrates an example associated with a call flow 1000 that may be used for RIS discovery and/or using a RIS for WTRU-to-WTRU communications. One or more of the following may apply. As shown in FIG. 10, an RIS controller may broadcast a discovery message, for example, to determine whether its capability(ies)is requested (e.g., needed) from surrounding WTRUs. A WTRUs 1002a (e.g., a source WTRU) may request to utilize the RIS and send a solicitation message to the RIS controller 1004. For example, the solicitation message may include source WTRU information, destination WTRU information, one or more RIS capabilities, one or more RIS modes, an application ID (for ProSe), etc. The one or more RIS capabilities may be required and/or expected RIS capabilities. The one or more RIS capabilities may include reflection, refraction, or absorption. The one or more RIS modes may include a passive mode, an active mode, and/or a semi-active mode. At 1010, based on the information provided in the solicitation message, the RIS controller 1004 may send a discovery message to a destination WTRU 1002c. For example, the discovery message may include source WTRU information, destination WTRU information, application ID (for ProSe), etc. At 1012, the destination WTRU 1002c may respond to the discovery message. For example, the destination WTRU 1002c may provide further information as part of the response message. At 1014, based on the destination WTRU's discovery message response, the RIS controller 1004 may send a solicitation message response to the source WTRU 1002a. The solicitation message response from the RIS controller 1004 may include control signaling information, supported side control information, etc., which may be used to control the RIS. Also, or alternatively, information relating to the destination WTRU 1002c may be provided as part of the solicitation message response. At 1016, the source WTRU 1002a may send control signaling to control the RIS and/or to utilize the requested RIS capability(ies) (e.g., in order to reach to the destination WTRU). After sending the RIS control signalling to the RIS controller 1004, the source WTRU 1002a may establish, at 1026, a unicast (e.g., PC5) link between the source WTRU 1002a and the destination WTRU 1002c via the RIS. For example, the source WTRU 1002a may send a transmission to the destination WTRU 1002c via the RIS based on the RIS control information. The transmission may be sent via the unicast link. For example, the transmission may be sent by the source WTRU 1002a to the destination WTRU 1002c using a RIS adaptation layer that is controlled by the source WTRU 1002a.

At 1018, the RIS controller 1004 may send a solicitation message response to the source WTRU 1002a in response to the solicitation message received, at 1008, from the source WTRU 1002a. The solicitation message response from the RIS controller 1004 may include control signaling information, supported side control information, etc., which may be used to control the RIS. At 1020, the source WTRU 1002a may send control signaling to control the RIS and/or to utilize the requested RIS capability(ies) (e.g., in order to send a discovery message to the destination WTRU). At 1022, the source WTRU 1002a may send a discovery message to the destination WTRU 1002c, e.g., via the RIS. At 1024, the destination WTRU 1002c may respond to the discovery message of the source WTRU 1002a, e.g., via the RIS. For example, the destination WTRU 1002c may send, at 1024, a discovery message response to the source WTRU 1002a via the RIS. After receiving the discovery message from the destination WTRU 1002c, the source WTRU 1002a may establish, at 1026, a unicast (e.g., PC5) link between the source WTRU 1002a and the destination WTRU 1002c via the RIS. For example, the source WTRU 1002a may send a transmission to the destination WTRU 1002c via the RIS based on the RIS control information. The transmission may be sent via the unicast link. For example, the transmission may be sent by the source WTRU 1002a to the destination WTRU 1002c using a RIS adaptation layer that is controlled by the source WTRU 1002a.

If, for example, the source WTRU 1002a experiences various indirect paths (e.g., via the RIS, via a WTRU-to-WTRU relay, etc.) to reach the destination WTRU 1002c, the source WTRU 1002a may determine and/or identify a path (e.g., from the existing paths) based on the source WTRU's signal strength, operating frequency, size of the resource pool, SL-RSRP, SL-RSSI, etc. The source WTRU 1002a may also, or alternatively, determine and/or identify the path via the RIS, for example, based on saving energy consumption at the source WTRU 1002a, link capacity, SINR, etc. In certain scenarios, the source WTRU 1002a may communicate with the destination WTRU 1002c via direct communication. The source WTRU 1002a may also, or alternatively, use the path via the RIS to improve communication reliability.

In certain scenarios, a RIS may be considered as a PIN element (e.g., with reflection, refraction and/or absorption capabilities). As described herein, such a PIN element may be referred to as a PIN Element with a RIS capability (PERC). The RIS controller may receive a discovery/announcement message from another PIN element that is part of an existing PIN. This PIN element may be a PEMC and/or a PEGC. If the RIS controller of the PERC receives the discovery/announcement message that includes a PIN ID, the RIS controller (e.g., the RIS controller of the PERC) may send a (e.g., direct) connection request. For example, the connection request may indicate the capabilities of the PERC (e.g., reflection, refraction, and/or absorption). The PERC may send the connection request to the PEMC and/or the PEGC.

In certain scenarios, the PEMC and/or the PEGC may send a discovery message. For example, the discovery message may include an indication of the requested (e.g., desired) capability (ies) for a PERC. For example, the PEMC and/or the PEGC may broadcast a discovery message with the desired capability indicated as reflection. The capability may be indicated as a bit string or service code within the discovery message. The discovery message may also, or alternatively, indicate a requested (e.g., required) frequency range for reflection (e.g., or any other capabilities for RIS), including, for example, licensed and unlicensed spectrum.

If a PERC receives the discovery message (e.g., from the PEMC and/or the PEGC), the PERC may respond to the discovery message. For example, the response to the discovery message may include one or more of the following: an indication for the requested (e.g., desired) capability (e.g., an indication that the desired capability is supported by PERC); an indication that the requested (e.g., required) frequency range is supported; etc. The PEMC/PEGC may send a solicitation request for PERC to join the PIN. The PERC may respond to the solicitation request message with the supported RIS control signaling information (e.g., the capabilities supported by the PERC). The PEMC/PEGC may establish a link with the PERC and may initiate control of the RIS elements to reflect the signal from PEMC/PEGC to a desired direction, for example, to reach out to another PIN element.

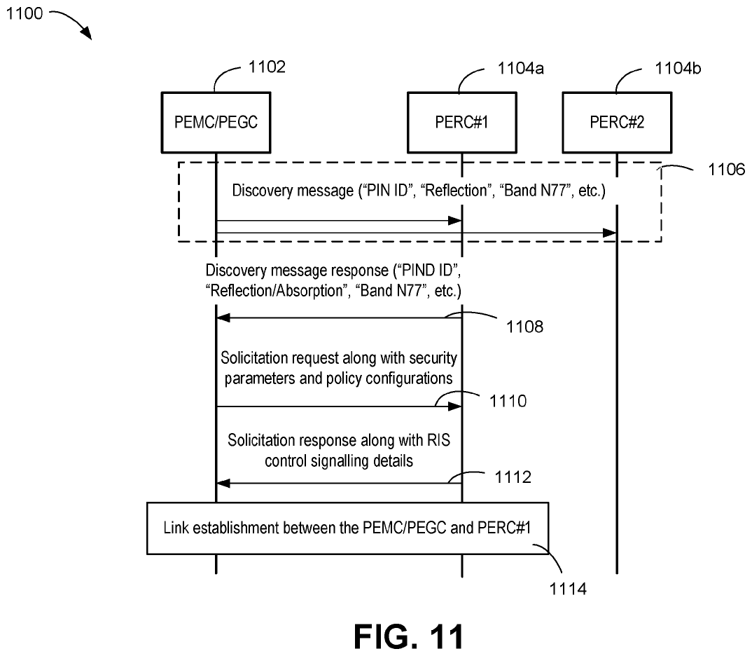

FIG. 11 illustrates an example call flow 1100 that may be used for PERC discovery and controlling of a RIS using a PEMC/PEGC 1102. One or more of the following may apply. At 1106, the PEMC/PEGC 1102 may broadcast a discovery message. The PEMC/PEGC 1102 may send the discovery message to determine whether a PERC with suitable capabilities is available (e.g., a PERC with reflection capabilities on frequency band N77). The discovery message may indicate a PIN ID and/or one or more desired PERC capabilities. At 1108, a PERC (e.g., PERC #1 1104a, shown in FIG. 11) may respond to the discovery message with an indication of the PERC's capabilities (e.g., PERC #1 has reflection and absorption capabilities on frequency band N77). As shown, PERC #2 1104b may not support the requested capabilities, and PERC #2 1104b may not send a response to the discovery message from the PEMC/PEGC 1102. At 1110, the PEMC/PEGC 1102 may send a solicitation request to PERC #1 1104a to join the PIN. The PEMC/PEGC 1102 may include one or more authorization/security parameters and/or one or more policy configurations associated with the PIN in the solicitation request sent at 1110 to the PERC #1 1104a. At 1112, PERC #1 1104a may respond to the solicitation request, for example, with RIS control signaling details. At 1114, the PEMC/PEGC 1102 may establish a link to PERC #1 1104a and may initiate control of the RIS elements associated with PERC #1 1104a (e.g., to propagate impinging signals to reach other PIN element(s)).

In certain scenarios, a RIS may be deployed as part of a CPN (e.g., RIS-integrated CPN). The RIS may be an off-the-shelf component and/or may be deployed along with a PRASs and/or an eRG. The RIS may be configured (e.g., pre-configured), for example, via a configuration portal on a webpage. An owner of the CPN may (re)configure the RIS in a way to enable the control of RIS, e.g., via the eRG and/or the PRASs.

If, for example, the eRG/PRAS is configured to control the RIS via the RIS controller, the eRG/PRAS may enable/authorize existing CPN WTRU(s) to control the RIS for WTRU-to-WTRU communication. The eRG/PRAS may provide the RIS controller with access information to the CPN WTRU(s). The CPN WTRU(s) may either use model A and/or model B discovery models to reach out to the RIS controller, as described herein. Also, or alternatively, the eRG/PRAS may configure the RIS to reflect impinging signals back to its source, and may transition the CPN WTRU(s) to a “scanning” mode (e.g., where the CPN WTRU(s) transmits a signal and measure the bounced back signal power to discover the RIS).

In certain scenarios, the eRG/PRAS may provide a frequency range information (e.g., an allowed frequency range), which may be used for WTRU-to-WTRU communication via the RIS. For example, the RIS may be configured (e.g., reconfigured) to operate (e.g., only operate) on the allowed frequency range.

In certain scenarios, the control plane protocol stack associated with the RIS controller for WTRU-to-WTRU communication may include RLC, MAC, PHY, and/or RIS adaptation layers, which may be placed over the RLC layer and/or may be used to tune properties of RIS/RIS elements. For example, the RIS adaptation layer may be used for one or more of the following: change/update the phase and/or amplitude of RIS elements (e.g., explicit or implicit phase and/or amplitude of RIS elements); change/update impinging signal directivity/beamforming characteristics/TCI states: to allocate (e.g., reallocate) RIS resources including RIS elements; change/update the UL/DL configuration; configure (e.g., reconfigure) timing advance offset alignment; turn on/off the RIS and/or RIS elements (e.g., individual RIS elements); to transition between different RIS capabilities (e.g., transition from reflection to refraction), etc. The source WTRU may control RIS via the RIS adaptation layer. The source WTRU may utilize PC5-RLC, PC5-MAC and PC5-PHY links at the RIS controller, for example, to transmit RIS control signaling.

In certain scenarios, the RIS adaptation layer, RLC, MAC, and/or PHY layers may not be terminated at the RIS controller. If, for example, the RIS adaptation layer, RLC, MAC, and/or PHY layers are not terminated at the RIS controller, the source WTRU and/or destination WTRU may adapt/configure the RIS elements to reflect the signal from/to the source WTRU to/from the destination WTRU.

In certain scenarios, the RIS adaptation layer may be terminated at RIS controller and used (e.g., only used) to adapt/configure the RIS elements to reflect signals from a source WTRU to a destination WTRU.

In certain scenarios, the RIS adaptation layer may be controlled by a source and/or destination WTRU, for example, based on the status of the PC5-RLC, PC5-MAC, and/or PC5-PHY layers between the source/destination WTRU and the RIS controller. Based on control signaling provided to the RIS adaptation layer at the RIS controller (e.g., from the source/destination WTRU), the RIS controller may adapt the RIS elements, for example, as part of the RIS-PHY layer at the RIS.

In certain scenarios, the control plane protocol stack associated with the RIS controller for WTRU-to-WTRU communications may include (e.g., only include) the PHY layer and/or the RIS adaptation layer. The source WTRU may control the RIS, e.g., via the RIS adaptation layer, based on information from PC5-RLC and PC5-MAC link between the source WTRU and destination WTRU. For example, the destination WTRU may also, or alternatively, control the RIS via the RIS adaptation layer. Based on the control signaling provided to the RIS adaptation layer at the RIS controller (e.g., from the source/destination WTRU), the RIS controller may adapt/configure the RIS elements as part of the RIS-PHY layer at the RIS.

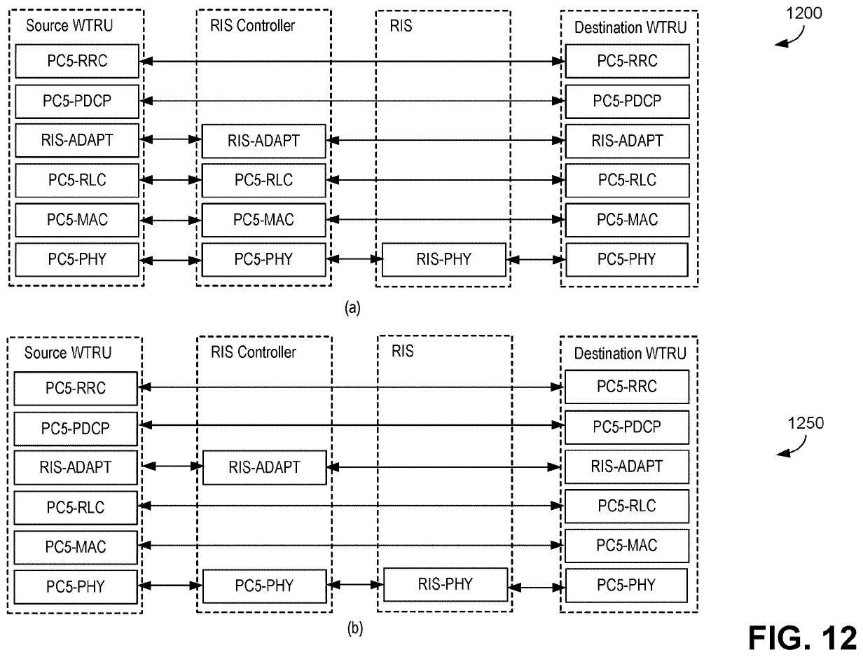

For example, FIG. 12 illustrates examples associated with a control plane protocol stacks 1200 and 1250 for WTRU-to-WTRU communications via the RIS. One or more of the following may apply.

In certain scenarios, the RIS adaptation layer may support multiple access, e.g., where a set of RIS elements may be used (e.g., dedicated) for transmissions from a source WTRU to a destination WTRU. Another set of RIS elements may be used (e.g., dedicated) for transmissions from the destination WTRU to the source WTRU.

In certain scenarios, the RIS adaptation layer may support multiple access, for example, where a set of RIS elements may be used (e.g., dedicated) for WTRU-to-WTRU transmissions (e.g., only WTRU-to-WTRU transmissions), and another set of RIS elements may be used (e.g., dedicated) for gNB/PRAS/PEMC/PEGC to WTRUs (e.g., including PIN elements, CPN WTRUs, WTRUs) transmissions. Such a scenario may also, or alternatively, apply to multiple network operators or multiple PINs existence scenario (e.g., where a set of RIS elements may be dedicated to operating on a first frequency range/part, e.g., BWP, and another set of RIS elements may be dedicated to operate on a second frequency range/part). As described herein, a frequency range/part may include, a BWP, component carrier, Pcell, Scell, MCG, SCG, and/or the like. Similarly, the techniques described herein may be used such that a set of RIS elements are semi-statically or dynamically configured for a specific frequency range/part.

In certain scenarios, the RIS adaptation layer may support multicast transmissions (e.g., in addition to unicast transmissions) and/or WTRU-to-WTRU transmissions. In RIS-based multicast transmission, for example, a gNB/PRAS/PEMC/PEGC/WTRU may control the RIS (e.g., to distribute signals in desired directions). For example, the RIS refraction capability may be used to perform multicast transmissions.

What is claimed is:

1-20. (canceled)

21. A first wireless transmit/receive unit (WTRU) configured to:
receive a discovery message associated with a reconfigurable intelligent surface (RIS);
send a solicitation message to an RIS controller in response to receipt of the discovery message, the solicitation message comprising one or more of capability information associated with the first WTRU, one or more RIS capabilities, one or more RIS modes, or an indication of a second WTRU;
receive a solicitation response message from the RIS controller in response to the solicitation message, the solicitation response message comprising RIS control information associated with the RIS; and
send, via the RIS, a transmission to the second WTRU based on the RIS control information.

22. The first WTRU according to claim 21, wherein the first WTRU is further configured to:
determine that the second WTRU has been discovered.

23. The first WTRU according to claim 22, wherein the solicitation response message indicates that the second WTRU has been discovered.

24. The first WTRU according to claim 21, wherein the discovery message comprises one or more capability parameters associated with the RIS.

25. The first WTRU according to claim 22, wherein the discovery message is a first discovery message, and wherein the first WTRU is further configured to:
send a second discovery message to the second WTRU via the RIS; and
receive a second discovery message response from the second WTRU via the RIS.

26. The first WTRU according to claim 21, wherein the one or more RIS capabilities comprise reflection, refraction, or absorption.

27. The first WTRU according to claim 21, wherein the one or more RIS modes comprise passive mode, active mode, or semi-active mode.

28. The first WTRU according to claim 25, wherein the first WTRU is further configured to establish a unicast link with the second WTRU via the RIS.

29. The first WTRU according to claim 21, wherein the transmission is sent to the second WTRU using an RIS adaptation layer that is controlled by the first WTRU.

30. The first WTRU according to claim 21, wherein the RIS is a PIN element with RIS capability (PERC).

31. A method performed by a first wireless transmit/receive unit (WTRU), the method comprising:
receiving a discovery message associated with a reconfigurable intelligent surface (RIS);
sending a solicitation message to an RIS controller in response to receipt of the discovery message, the solicitation message comprising one or more of capability information associated with the first WTRU, one or more RIS capabilities, one or more RIS modes, or an indication of a second WTRU;
receiving a solicitation response message from the RIS controller in response to the solicitation message, the solicitation response message comprising RIS control information associated with the RIS; and
sending, via the RIS, a transmission to the second WTRU based on the RIS control information.

32. The method of claim 31, further comprising:
determining that the second WTRU has been discovered.

33. The method of claim 32, wherein solicitation response message indicates that the second WTRU has been discovered.

34. The method of claim 31, wherein the discovery message comprises one or more capability parameters associated with the RIS.

35. The method of claim 32, wherein the discovery message is a first discovery message, further comprising:
sending a second discovery message to the second WTRU via the RIS; and
receiving a second discovery message response from the second WTRU via the RIS.

36. The method of claim 31, wherein the one or more RIS capabilities comprise reflection, refraction, or absorption.

37. The method of claim 31, wherein the one or more RIS modes comprise passive mode, active mode, or semi-active mode.

38. The method of claim 35, further comprising:
establishing a unicast link with the second WTRU via the RIS.

39. The method of claim 31, wherein the transmission is sent to the second WTRU using an RIS adaptation layer that is controlled by the first WTRU.

40. The method of claim 31, wherein the RIS is a PIN element with RIS capability (PERC).
